(19) United States
(12) Patent Application Publication
(10) Pub. No.: US 2015/0022687 A1
(43) Pub. Date: Jan. 22, 2015

(54) SYSTEM AND METHOD FOR AUTOMATIC EXPOSURE AND DYNAMIC RANGE COMPRESSION

(71) Applicant: Qualcomm Technologies, Inc., San Diego, CA (US)

(72) Inventor: Micha Galor, Tel Aviv (IL)

(21) Appl. No.: 13/946,277

(22) Filed: Jul. 19, 2013

(51) Int. Cl. H04N 5/235; H04N 5/243

(52) U.S. Cl. CPC H04N 5/2355; H04N 5/243
USPC 348/229.1

(57) ABSTRACT

A method of capturing a digital image with a digital camera includes determining a first exposure level for capturing an image based on a first luminance level of the image, determining a second exposure level for capturing the image based on a threshold exposure level of the image, configuring an exposure level of a sensor of the digital camera based on the second exposure level, capturing the image as a digital image, and adding a non-linear digital gain to the digital image based on a difference between the first exposure level and the second exposure level.

### BACKGROUND

1. Technical Field

The present invention relates to systems and methods for automatic exposure and dynamic range compression.

2. Discussion

Digital cameras use various systems to enable photographers and videographers to capture images of scenes. Scenes can vary in overall light levels and dynamic ranges of light within the scene. Digital cameras can include algorithms for automatically setting exposure settings of the camera, including settings such as shutter speed, aperture, and analog and digital gain. The algorithms are based on the light levels and dynamic ranges of the scene. Typically, digital images capture a limited range of the intensities of light of a scene that can be observed by a human. Various algorithms are utilized by digital cameras to improve the dynamic range captured in the digital images.

### SUMMARY OF INVENTION

In accordance with at least one aspect of the embodiments disclosed herein, it is recognized that image processing algorithms can be applied to digital images to improve contrast and dynamic range of the digital image. The image processing algorithms can include adjusting automatic exposure settings to generate a digital image on which the image processing algorithms can optimally be applied. For example, the image processing algorithm can include adjusting the automatic exposure settings to a lower setting, based on a threshold level (e.g., comparing a brightness level of a percentile of pixels to a threshold), than would typically be used. The image processing algorithm can then apply a non-linear gain to the digital image based on the difference between the lower automatic exposure setting and the typical automatic exposure setting.

Some aspects of the present disclosure are directed toward a method of capturing a digital image with a digital camera including determining a first exposure level for capturing an image based on a first luminance level of the image, determining a second exposure level for capturing the image based on a threshold exposure level of the image, configuring an exposure level of a sensor of the digital camera based on the second exposure level, capturing the image as a digital image, and adding a non-linear digital gain to the digital image based on a difference between the first exposure level and the second exposure level.

In some embodiments, determining the second exposure level includes determining an exposure level at which a threshold percentage of pixels of the digital image have a luminance value below a threshold luminance value.

In some embodiments, determining the first exposure level includes determining an exposure level based also at least on a histogram of the image.

In some embodiments, adding the non-linear gain includes adding a first gain to a first portion of the pixels and a second gain to a second portion of the pixels. In some embodiments, the first portion of the pixels includes a portion of pixels below a threshold luminance value. In some embodiments, the first gain includes a gain such that adding the first gain results in a second luminance level of each of the pixels of the first portion based on the first exposure level. In some embodiments, the second gain includes a gain such that adding the second gain results in a maximum luminance level based on the first exposure level.

In some embodiments, adding the non-linear gain includes adding a first gain to a first portion of the pixels and no gain to a second portion of the pixels.

In some embodiments, adding the non-linear gain includes adjusting a gamma correction factor.

In some embodiments, adding the non-linear gain includes adjusting a dynamic range compression factor.

In some embodiments, the first and second exposure levels are determined concurrently based on a first and second subset of the pixels, respectively.

In some embodiments, the threshold exposure level is determined for each color channel separately. In some embodiments, the second exposure level is determined based on the lowest of the threshold exposure levels of each color channel. In some embodiments, the second exposure level is determined based on a weighted average of the threshold exposure levels of each color channel.

In some embodiments, determining the second exposure level further includes comparing a difference between the first exposure and the second exposure level to a predetermined maximum difference and based on the comparison, setting the second exposure level to a level based on the first exposure level and the predetermined maximum difference.

Some aspects are also directed toward a digital camera system for image processing including g a processor configured for determining a first exposure level for capturing an image based on a first luminance level of the image, determining a second exposure level for capturing the image based on a threshold exposure level of the image, configuring an exposure level of a sensor of the digital camera based on the second exposure level, capturing the image as a digital image, and adding a non-linear digital gain to the digital image based on a difference between the first exposure level and the second exposure level.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of the embodiments disclosed herein. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 illustrates a functional block diagram of an example digital camera in accordance with some embodiments of the present disclosure;

FIG. 2 illustrates a flow chart of a process in accordance with the prior art;

FIG. 3 illustrates a flow chart of an example process in accordance with some embodiments of the present disclosure;

FIGS. 4A-4C illustrate histograms for an example algorithm in accordance with some embodiments of the present disclosure;

FIG. 5 illustrates a graph depicting an example output in accordance with some embodiments of the present disclosure;

FIG. 6 illustrates a graph depicting an example output in accordance with some embodiments of the present disclosure;

FIG. 7 illustrates a graph depicting example outputs in accordance with some embodiments of the present disclosure; and

FIG. 8 illustrates flow charts of example processes in accordance with some embodiments of the present disclosure.

### DETAILED DESCRIPTION

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features discussed in connection with any one or more examples are not intended to be excluded from a similar role in any other examples.

Also, the phraseology and terminology used herein is for the purpose of description and should not be regarded as limiting. Any references to examples or elements or acts of the systems and methods herein referred to in the singular may also embrace examples including a plurality of these elements, and any references in plural to any example or element or act herein may also embrace examples including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Embodiments of the present invention relate to automatic exposure and dynamic range compression for digital cameras. It should be appreciated that the term “digital camera” used herein includes, but is not limited to, dedicated cameras as well as camera functionality performed by any electronic device (e.g., mobile phones, personal digital assistants, etc.). In addition, the methods and systems described herein may be applied to a plurality of images arranged in a time sequence (e.g., a video stream). The use herein of the term “module” is interchangeable with the term “block” and is meant to include implementations of processes and/or functions in software, hardware, or a combination of software and hardware.

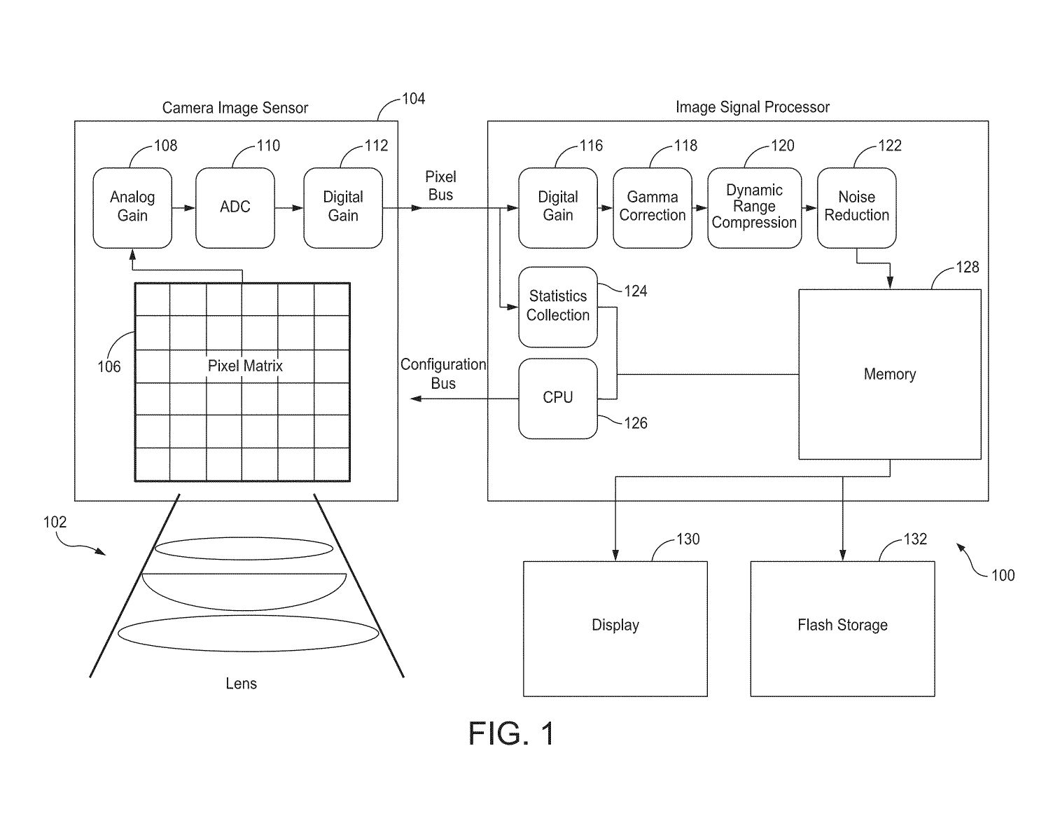

FIG. 1 illustrates an example digital camera 100. The digital camera 100 includes a lens system 102. The lens system 102 focuses light on an image sensor 104. The image sensor 104 includes a photo-diode pixel matrix 106, an analog amplifier 108, an analog-to-digital converter (ADC) 110, and a digital gain unit 112. The digital camera 100 also includes an image signal processor 114, which includes a digital gain module 116, a gamma correction module 118, a dynamic range compression module 120, and a noise reduction module 122. The image signal processor 114 also includes a statistic acquisition module 124, a processor 126, and a memory 128. The digital camera 100 also includes a display 130 and a flash storage device 132.

The image sensor 104 receives the light and translates received light into voltages for each pixel of the pixel matrix 106. The analog amplifier 108 receives the voltages from the pixel matrix 106 and amplifies the voltage of the pixels of the pixel matrix 106. The ADC 110 receives the voltages from the analog amplifier 108 and samples the voltages and provides digital values to the digital gain unit 112, which can amplify the digital values.

The digital values are provided to the image signal processor 114. In some embodiments, the digital values are received by the digital gain module 116 of the image signal processor 114, which can further amplify the digital values, for example, by multiplying the digital values by a number or several numbers based on an algorithm.

The digital gain module 116 outputs digital values, which may be amplified, to the gamma correction module 118. In some embodiments, the gamma correction module 118 transforms the digital values of the pixels based on an algorithm to correct a gamma component of the pixel values. For example, in some embodiments, the gamma correction module 118 applies a non-linear transformation based on a look-up table. For each input digital value to the gamma correction module 118, the look-up table provides a specific output value.

The output values are provided to the dynamic range compression module 120. The dynamic range compression module 120 applies an algorithm to the pixel values to improve a dynamic range of the pixels. For example, in some embodiments, the dynamic range compression module 120 applies a smart spatial-aware tone mapping algorithm, such as the ZLight algorithm by CSR.

The statistics acquisition module 122 receives the digital values after the tone mapping algorithm has been applied by the dynamic range compression module 120. In some embodiments, the statistics acquisition module 122 collects statistics related to the exposure of the image, such as a decimated luminance image and a histogram. The statistics acquisition module 122 can collect other statistics related to other aspects of the image as well.

In some embodiments, the processor 126 receives the pixel values and the statistics collected by the statistics acquisition module 122. The processor 126 analyzes the statistics and applies an automatic exposure algorithm, which can apply a configuration to the pixel processing pipe and/or configure the sensor 104, such as setting the sensor 104 to specific exposure levels based on the received pixel values and the statistics.

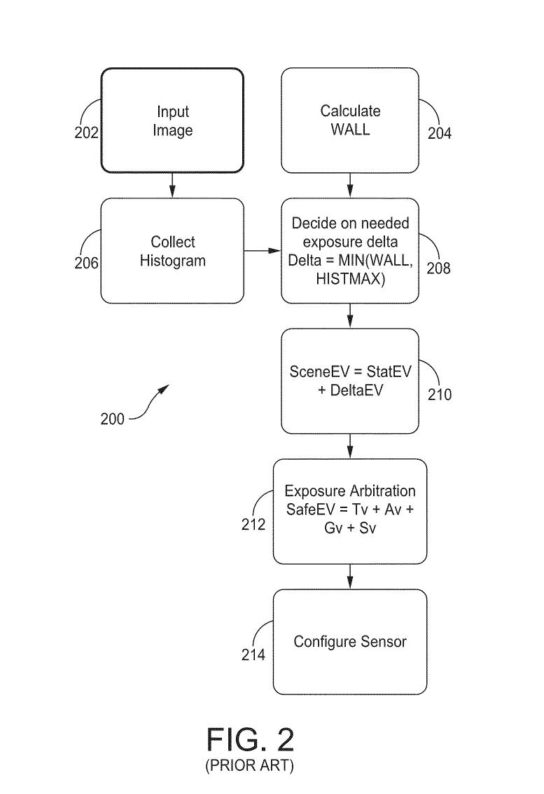

FIG. 2 shows a flow chart of an automatic exposure algorithm 200 according to the prior art. The automatic exposure algorithm 200 can be used to automatically adjust exposure setting of digital camera 100, such as shutter speed and aperture level. The automatic exposure algorithm 200 starts with receiving an input image at act 202. The input image is provided to act 204, where a weighted average luminance level (WALL) of the input image is calculated. The WALL can be a weighted average of luminance values of the pixels of the input image. The input image is also provided to act 206, which generates a histogram based on the input image, such as the luminance values of the pixels of the image.

At act 208, the WALL and the histogram are used as inputs to an algorithm which decides on an exposure delta that is to be applied to the input image. The exposure delta can be determined as a minimum between the WALL and a maximum value of the histogram. At act 210, an exposure value for the scene (SceneEV) is calculated. The SceneEV is based on the static exposure value (StatEV), which is the exposure value of the input image received at act 202, and the exposure delta calculated at act 208. At act 212, exposure settings are determined Exposure settings include variables that can be controlled on the camera that affect the exposure on the digital image. For example, exposure settings can include shutter speed, aperture, and analog and digital gain. These settings are adjusted to add up to the SceneEV. The levels that are chosen for each setting and the tradeoffs can be determined by various factors, including camera settings determined by the user. At act 214, the sensor is configured based on the adjusted exposure settings.

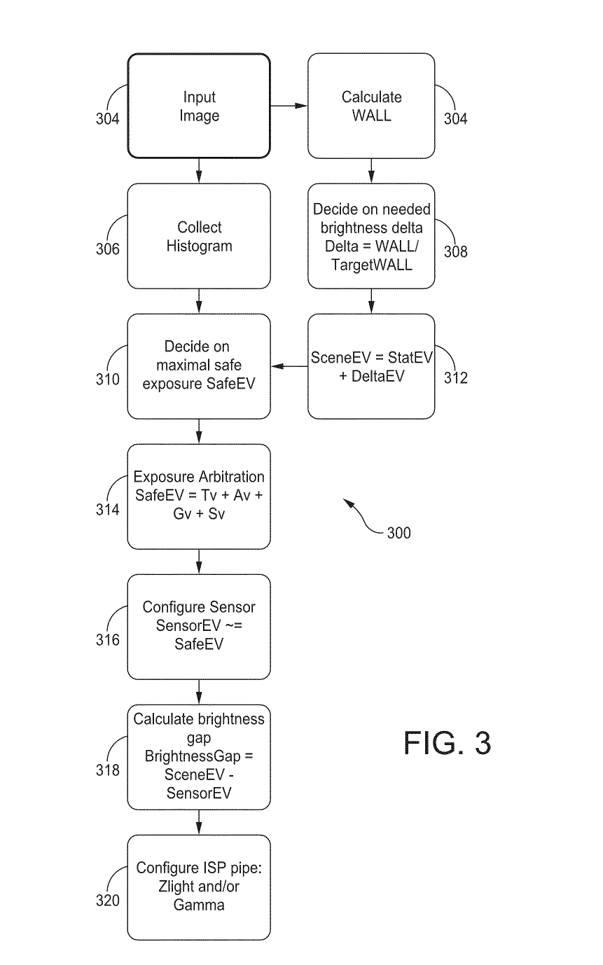

FIG. 3 shows a flow chart of an example automatic exposure algorithm 300 according to some embodiments of the present disclosure. The automatic exposure algorithm 300 starts with receiving an input image at act 302. In some embodiments, the input image can be received by the digital camera 100, for example by sampling images of a scene prior to a user capturing the image, such as when the user is focusing and/or framing a scene for capturing. At act 304, a weighted average luminance level (WALL) is calculated for the input image. The WALL can be calculated using algorithms similar to those used in the automatic exposure algorithm 200 of the prior art. The input image can also be provided to act 306, where a histogram is generated based on the input image. The histogram can be generated using algorithms similar to those used in the automatic exposure algorithm 200 of the prior art.

The WALL can be used to determine a brightness delta at act 308. The brightness delta can be based on the WALL and a target weighted average luminance level (TargetWALL), which can correspond to a desired luminance level of the digital image. The TargetWALL can be determined based on predetermined settings, for example, based on settings configured by the user. In some embodiments, the TargetWALL can vary depending on the input image. In some embodiments, the TargetWALL provides a target value independent of the image. The brightness delta can be determined based on a quotient of the WALL of the input image divided by the TargetWALL.

At act 310, a safe exposure value (SafeEV) is determined In some embodiments, the

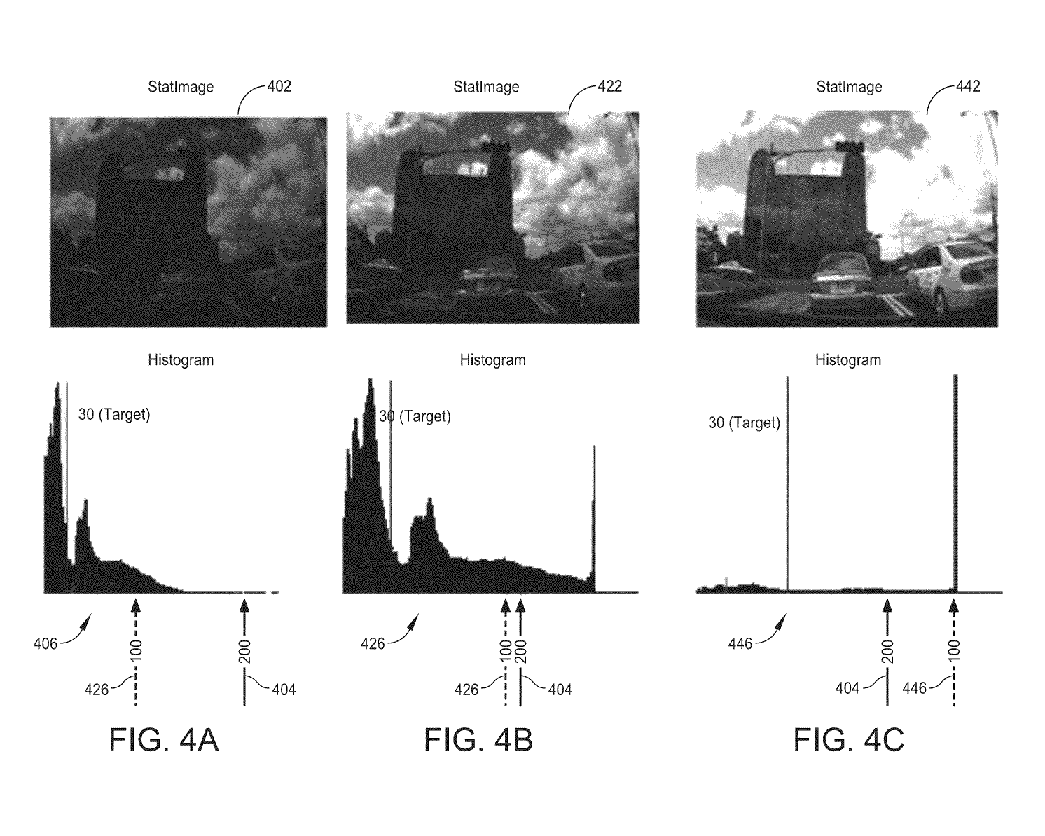

SafeEV is an exposure level that is set to minimize oversaturation of pixels in a digital image of a scene. SafeEV can be determined by various algorithms, such as determining an exposure level at which a threshold percentage of pixels of the digital image have a luminance value below a threshold luminance value. For example, the SafeEV can be the exposure level at which 95% of the pixels have a luminance value of 225 (out of 255) or less. Another example algorithm for determining SafeEV is discussed further below with reference to FIG. 4. In some embodiments, the SafeEV can be limited to a threshold amount below the SceneEV.

At act 312, an exposure value for the scene (SceneEV) is calculated. The SceneEV can be based on the static exposure value (StatEV), which is the exposure value of the input image received at act 302, and the brightness delta calculated at act 308. For example, the SceneEV can be a sum of the StatEV and the brightness delta.

At act 314, exposure settings are determined based on the SafeEV. The shutter speed, aperture, and digital and analog gains are adjusted to add up to the SafeEV. The levels that are chosen for each setting and the tradeoffs between settings can be determined by various factors, including camera settings determined by the user. At act 316, the sensor is configured based on the adjusted exposure settings for the SafeEV.

At act 318, a brightness gap is calculated. The brightness gap is based on the difference between the SceneEV and the SafeEV. In some instances, the SafeEV will be less than the SceneEV, as the SafeEV determines an exposure level designed to minimize overexposure. For example, if a scene contains bright portions, the SceneEV might determine an exposure level based on an overall luminance, which results in an image with a well exposed image overall, but with the bright portions being overexposed. The SafeEV, in order to minimize overexposure, might be determined at a level based so that the bright portions of the image will not be overexposed, resulting in a darker overall image.

At act 320, the image signal processor (ISP) pipe is configured based on the brightness gap. The ISP pipe can include applying a non-linear gain to the captured image to make up for the difference in exposure level between the SafeEV and the SceneEV. The configured ISP pipe allows the image to be captured at the SafeEV, which can be lower than the SceneEV, to minimize overexposed regions of the image, and then to compensate for the lower exposure level for the remainder of the image. Algorithms for configuring the ISP pipe are described further below.

FIGS. 4A, 4B, and 4C show an example algorithm for determining SafeEV. The same scene can be sampled multiple times with varying levels of exposure. For example, FIG. 4A shows the scene sampled at a lower exposure level, resulting in an underexposed image 402. FIG. 4B shows the scene sampled at an intermediate exposure level, resulting in an intermediate-exposed image 422. FIG. 4C shows the scene sampled at a higher exposure level, resulting in an overexposed image 442. For each sampled image 402, 422, 442, a corresponding histogram 400, 420, 440 is generated, which shows a distribution of the brightness of the pixels. For example, for FIG. 4A, the histogram 402 shows that a majority of the pixels have a brightness of less than half of the maximum brightness. The histograms can also show a threshold brightness. For example, the histogram 402 of FIG. 4A shows a threshold brightness 404 represented by a solid arrow at a brightness level of 200. The histogram 402 also shows an upper 20^{th} percentile point 406 represented by a dashed arrow. The upper 20^{th} percentile point is the brightness at which 80 percent of the pixels have a lower brightness level and 20 percent of the pixels have an equal or higher brightness level. The upper 20^{th} percentile point 406 for the example distribution of the underexposed image 402 is 100.

In contrast, the histogram 440 of FIG. 4C shows a majority of the pixels having a brightness level of 255, the maximum brightness. The overexposed image 442 reflects the luminance saturation of many of the pixels. The histogram 440 shows the threshold brightness 404 of 200 and an upper 20^{th} percentile point 446 of 255, showing more than 20 percent of the pixels have a brightness level of 255.

For FIG. 4B, the histogram 420 shows the threshold brightness 404 of 200, as well as an upper 20^{th} percentile point 426 of 190. Thus, the intermediate-exposed image 422 can have an exposure level that is close to the SafeEV.

In some embodiments, multiple images can be sampled simultaneously. For example, the image sensor 104 of the digital camera 100 can be configured to set different exposure levels concurrently. For example, the pixels on the image sensor 104 can be interlaced so that, for example, the odd lines are set a first exposure level and the even lines are set at a second exposure levels. The different exposure levels can be used to sample a scene at different exposure levels as described above. The different exposure levels can also be used to determine different threshold exposure values, such as SceneEV and SafeEV as described above.

In some embodiments, a SafeEV can be determined separately for each color channel. The algorithm can choose between the separate SafeEVs, for example, setting the exposure level to the lowest SafeEV, or the algorithm can combine the SafeEVs, such as averaging the SafeEVs or calculating a weighted average of the SafeEVs for each color channel. For example, the SafeEV for the green color channel can be given a greater weight than the SafeEV for the red color channel, and the SafeEV for the blue color channel can be given no weight or a relatively lower weight. These weighted SafeEVs can be averaged to determine the SafeEV for setting the exposure level.

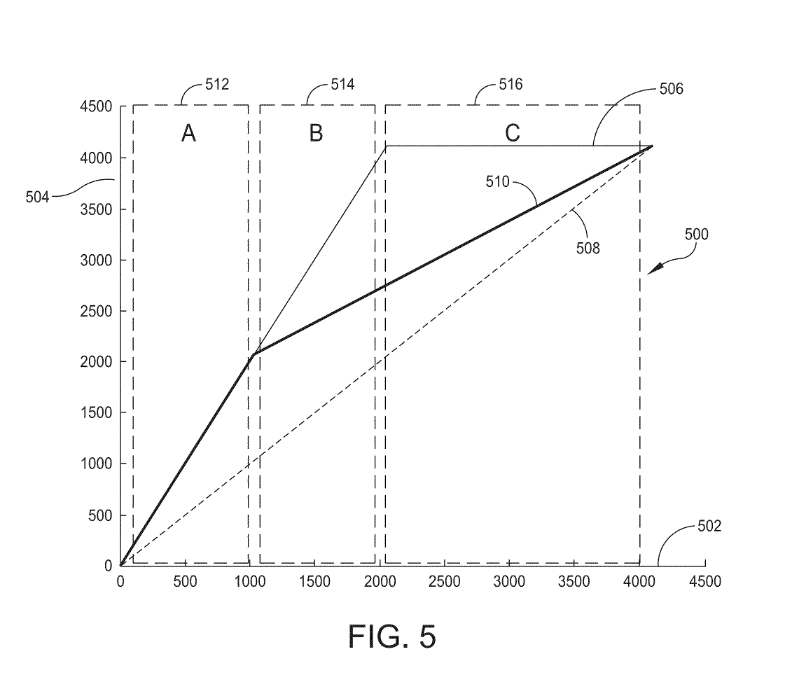

FIG. 5 shows a graph 500 of an example algorithm for configuring the ISP pipe to apply a non-linear late gain to compensate for setting the exposure settings according to the SafeEV. The graph 500 shows input pixel luminance values 502 and resulting output pixel luminance values 504. A first plot 506 shows the output pixel luminance values 504 based on a typical digital gain. The output pixel luminance values 504 increase linearly in section A 512 and section B 514, at a rate corresponding to the amount of the digital gain. At section C 516, the pixel luminance values have saturated and reached a maximum output value.

In comparison, a second plot 510 shows the output pixel luminance values 504 resulting from applying the non-linear late gain. In some embodiments, in the first section, section A 512, the output pixel luminance values 504 match those of the first plot 506 and the non-linear late gain generates the same output as the typical gain. Pixels with an input pixel luminance value of those in section A 512 will look no different between the typical digital gain and the non-linear late gain. In section B 514, the gain applied is different from the typical gain. The gain applied from section B 514 and section C 516 can be a second linear gain, resulting in reaching the maximum output luminance value at or near the end of the maximum input luminance value. As a result, in section C 516, where the first plot 506 reflecting typical gain outputs saturated pixel brightness values, the non-linear late gate outputs non-saturated pixels, retaining information in brighter portions of the image. In section B 514, the output pixel luminance values 504 may be less bright and/or provide less contrast. The junction point between section A 512 and section B 514 can be chosen so that a large number of the pixels fall in section A 512 (e.g., 80%), so that a majority of the image can be exposed similar to those using a typical gain, while oversaturation is minimized While one level of non-linear late gain is illustrated in the graph 500, as with typical gain levels, the amount of gain applied can vary, for example, depending on an overall light level of the scene, user setting configurations, and other factors.

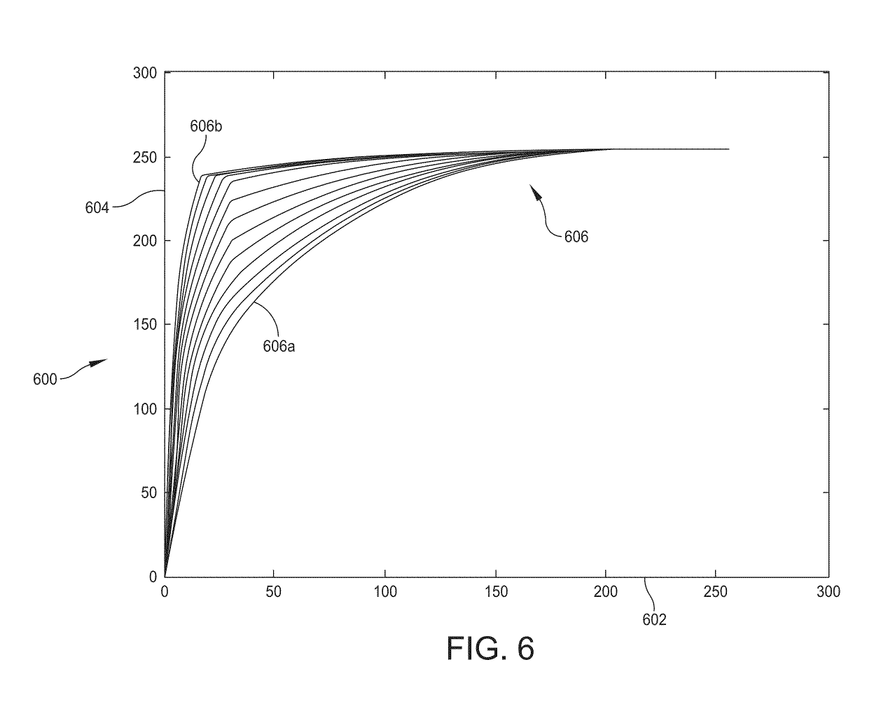

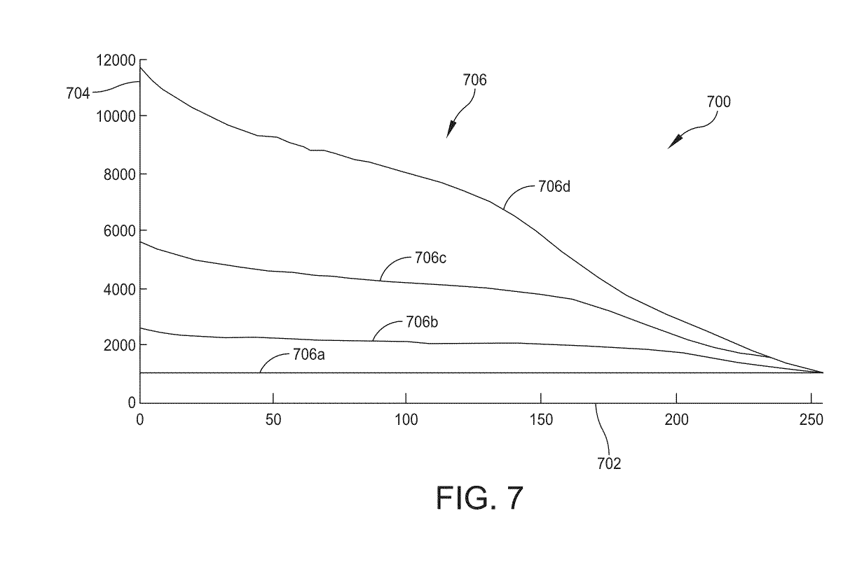

FIG. 6 shows a graph 600 illustrating several curves 606 combining a static gamma correction, such as a gamma correction applied by the gamma correction module 118 with various non-linear late gain curves. By combining the application of the non-linear late gain with the gamma correction, the non-linear late gain can be applied to the image using the existing hardware in the digital camera 100. In some embodiments, the non-linear late gain can also be applied by the dynamic range compression module 120 by reconfiguring the dynamic range compression algorithm to account for the non-linear late gain to be applied to the digital pixel values, as shown in FIG. 7. The graph 600 shows the input pixel values 602 and the resulting output pixel values 604 as a result of applying a gamma correction algorithm modified by varying amounts of non-linear late gain. The lowest curve 606a reflects the lowest amount of non-linear late gain, while the highest curve 606b reflects the highest amount of non-linear late gain. As more gain is applied, a greater contrast can be provided for a smaller section of the brightness spectrum of the image.

FIG. 7 shows a graph 700 illustrating several curves 706 combining the dynamic range compression algorithm with the non-linear late gain. Similar to combining the non-linear late gain with the gamma correction, by combining the non-linear late gain with the dynamic range compression, the non-linear late gain can be applied to the image using existing hardware. The graph 700 shows the input pixel values 702 and the resulting output pixel values 704 as a result of applying a dynamic range compression algorithm (e.g., ZLight) modified by varying amounts of non-linear late gain. The lowest curve 706a reflects the lowest amount of non-linear late gain, while the highest curve 706d reflects the highest amount of non-linear late gain.

While curves of varying amounts of non-linear late gain have been shown, non-linear late gain values in between the curves shown can also be applied. For example, the curves 706a, 706b, 706c, 706d of FIG. 7 can apply to non-linear late gains of 1, 2, 4, and 8, respectively. However, for example, a non-linear late gain of 5 or 3.27 can be applied to the pixel values. In some embodiments, the amount of non-linear late gain that is applied is determined based on a difference between the exposure value of a scene and the exposure value of the sensor, such as the brightness gap calculated in act 318 of example process 300. In some embodiments, the non-linear late gain curves, such as the modified gamma correction curves 606 or the modified dynamic range compression curves 706 can be calculated offline, such as by inputting the curves into a processor or module of the digital camera. At runtime, when the image is being processed, one or more of the curves can be selected for applying.

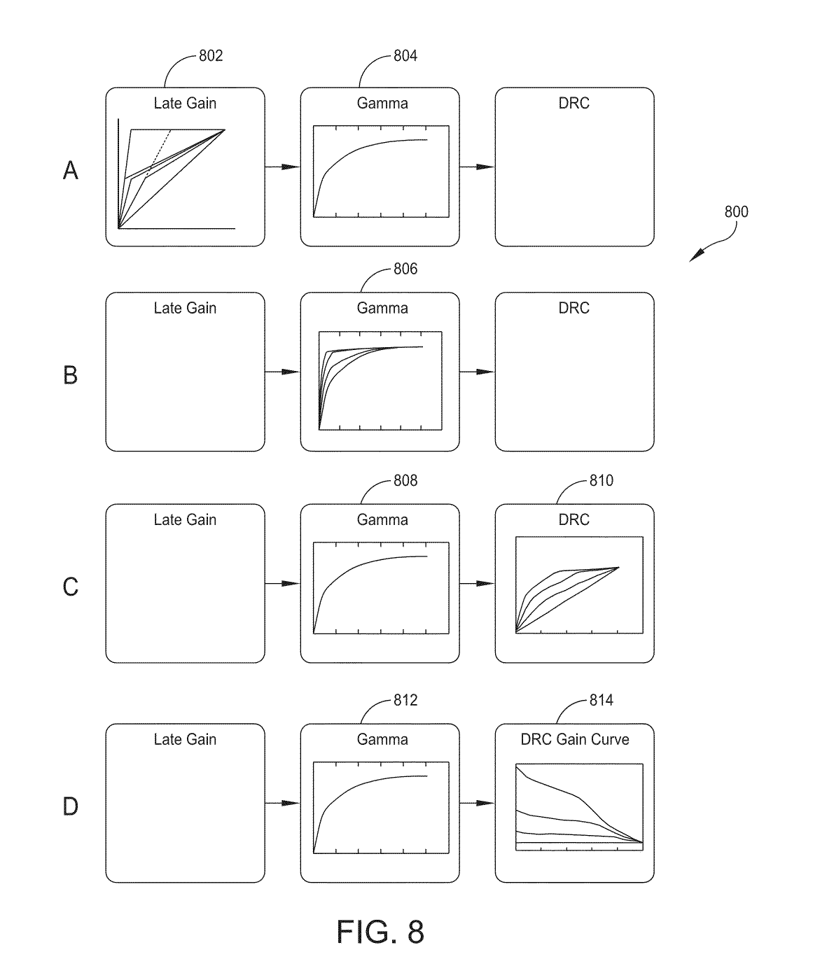

FIG. 8 shows flow charts 800 of example implementations of the non-linear late gain.

For example, chart A shows a separate non-linear late gain module 802. The separate non-linear late gain module can be implemented as a hardware component added to the digital camera 100 or as a separate software module, for example, added to the image signal processor 114. The non-linear gain module 802 is followed by a gamma correction module 804, which can apply a gamma correction algorithm.

Chart B shows a gamma correction module 806 that includes the non-linear late gain, as shown in the curves of the gamma correction module 806. The modified gamma correction algorithm curves can be similar to those discussed above with reference to FIG. 6.

Chart C shows a gamma correction module 808 unmodified by the non-linear late gain. Rather, the non-linear late gain is added to a dynamic range compression module 810. The modified dynamic range compression curves show function responses of the dynamic range compression module modified by each of the non-linear late gain curves.

Chart D shows a gamma correction module 812 with a static gamma correction algorithm, unmodified by the non-linear late gain. The gamma correction module 812 is followed by a dynamic range compression module 814 that includes the non-linear late gain. The dynamic range compression module 814 shows the dynamic range compression curves modified by the non-linear late gain. One or a combination of each of these flow charts can be used to implement the non-linear late gain for compensating for setting exposure settings to a safe level to minimize overexposure.

In some embodiments, the digital camera 100 includes the image processor 114 to implement at least some of the aspects, functions and processes disclosed herein. The image processor 114 performs a series of instructions that result in manipulated data. The image processor 114 may be any type of processor, multiprocessor or controller. Some exemplary processors include processors with ARM11 or ARM9 architectures or MIPS architectures. The image processor 114 is connected to other system components, including one or more memory devices 128.

The memory 128 stores programs and data during operation of the digital camera 100. Thus, the memory 128 may be a relatively high performance, volatile, random access memory such as a dynamic random access memory (“DRAM”) or static memory (“SRAM”). However, the memory 128 may include any device for storing data, such as a flash memory or other non-volatile storage devices. Various examples may organize the memory 128 into particularized and, in some cases, unique structures to perform the functions disclosed herein. These data structures may be sized and organized to store values for particular data and types of data.

The data storage element 132 includes a writeable nonvolatile, or non-transitory, data storage medium in which instructions are stored that define a program or other object that is executed by the image processor 114. The data storage element 132 also may include information that is recorded, on or in, the medium, and that is processed by the image processor 114 during execution of the program. More specifically, the information may be stored in one or more data structures specifically configured to conserve storage space or increase data exchange performance. The instructions may be persistently stored as encoded signals, and the instructions may cause the image processor 114 to perform any of the functions described herein. The medium may, for example, be optical disk, magnetic disk or flash memory, among others. In operation, the image processor 114 or some other controller causes data to be read from the nonvolatile recording medium into another memory, such as the memory 128, that allows for faster access to the information by the image processor 114 than does the storage medium included in the data storage element 132. The memory may be located in the data storage element 132 or in the memory 128, however, the image processor 114 manipulates the data within the memory, and then copies the data to the storage medium associated with the data storage element 132 after processing is completed. A variety of components may manage data movement between the storage medium and other memory elements and examples are not limited to particular data management components. Further, examples are not limited to a particular memory system or data storage system.

The digital camera 100 also includes one or more interface devices such as input devices, output devices and combination input/output devices. Interface devices may receive input or provide output. More particularly, output devices may render information for external presentation. Input devices may accept information from external sources. Examples of interface devices include microphones, touch screens, display screens, speakers, buttons, etc. Interface devices allow the digital camera 100 to exchange information and to communicate with external entities, such as users and other systems.

Although the digital camera 100 is shown by way of example as one type of digital camera upon which various aspects and functions may be practiced, aspects and functions are not limited to being implemented on the digital camera 100 as shown in FIG. 1. Various aspects and functions may be practiced on digital cameras having a different architectures or components than that shown in FIG. 1. For instance, the digital camera 100 may include specially programmed, special-purpose hardware, such as an application-specific integrated circuit (“ASIC”) or a system on a chip (“SoC”) tailored to perform a particular operation disclosed herein. It is appreciated that the digital camera 100 may be incorporated into another electronic device (e.g., mobile phone, personal digital assistant etc.) and is not limited to dedicated digital cameras.

The image sensor 104 may include a two dimensional area of sensors (e.g., photo-detectors) that are sensitive to light. In some embodiments, the photo-detectors of the image sensor 104, in some embodiments, can detect the intensity of the visible radiation in one of two or more individual color and/or brightness components. For example, the output of the photo-detectors may include values consistent with a YUV or RGB color space. It is appreciated that other color spaces may be employed by the image sensor 104 to represent the captured image.

In various embodiments, the image sensor 104 outputs an analog signal proportional to the intensity and/or color of visible radiation striking the photo-detectors of the image sensor 104. The analog signal output by the image sensor 104 may be converted to digital data by the analog-to-digital converter 110 for processing by the image processor 114. In some embodiments, the functionality of the analog-to-digital converter 110 is integrated with the image sensor 104. The image processor 114 may perform variety of processes to the captured image. These processes may include, but are not limited to, one or more processes for automatic exposure and minimizing overexposure.

Having thus described several aspects of at least one example, it is to be appreciated various alterations, modification, and improvements will readily occur to those skilled in the art. Such alterations, modifications, and improvements are intended to be part of this disclosure, and are intended to be within the scope of the embodiments disclosed herein. Accordingly, the foregoing description and drawings are by way of example only.

What is claimed is:

1. A method of capturing a digital image with a digital camera comprising:
determining a first exposure level for capturing an image based on a first luminance level of the image;
determining a second exposure level for capturing the image based on a threshold exposure level of the image;
configuring an exposure level of a sensor of the digital camera based on the second exposure level;
capturing the image as a digital image; and
adding a non-linear digital gain to the digital image based on a difference between the first exposure level and the second exposure level.

2. The method of claim 1, wherein determining the second exposure level comprises determining an exposure level at which a threshold percentage of pixels of the digital image have a luminance value below a threshold luminance value.

3. The method of claim 1, wherein determining the first exposure level comprises determining an exposure level based also at least on a histogram of the image.

4. The method of claim 1, wherein adding the non-linear gain comprises adding a first gain to a first portion of the pixels and a second gain to a second portion of the pixels.

5. The method of claim 4, wherein the first portion of the pixels comprises a portion of pixels below a threshold luminance value.

6. The method of claim 4, wherein the first gain comprises a gain such that adding the first gain results in a second luminance level of each of the pixels of the first portion based on the first exposure level.

7. The method of claim 4, wherein the second gain comprises a gain such that adding the second gain results in a maximum luminance level based on the first exposure level.

8. The method of claim 1, wherein adding the non-linear gain comprises adding a first gain to a first portion of the pixels and no gain to a second portion of the pixels.

9. The method of claim 1, wherein adding the non-linear gain comprises adjusting a gamma correction factor.

10. The method of claim 1, wherein adding the non-linear gain comprises adjusting a dynamic range compression factor.

11. The method of claim 1, wherein the first and second exposure levels are determined concurrently based on a first and second subset of the pixels, respectively.

12. The method of claim 1, wherein the threshold exposure level is determined for each color channel separately.

13. The method of claim 12, wherein the second exposure level is determined based on the lowest of the threshold exposure levels of each color channel.

14. The method of claim 12, wherein the second exposure level is determined based on a weighted average of the threshold exposure levels of each color channel.

15. The method of claim 1, wherein determining the second exposure level further comprises:
comparing a difference between the first exposure and the second exposure level to a predetermined maximum difference; and
based on the comparison, setting the second exposure level to a level based on the first exposure level and the predetermined maximum difference.

16. A digital camera system for image processing comprising a processor configured for:
determining a first exposure level for capturing an image based on a first luminance level of the image;
determining a second exposure level for capturing the image based on a threshold exposure level of the image;
configuring an exposure level of a sensor of the digital camera based on the second exposure level;
capturing the image as a digital image; and
adding a non-linear digital gain to the digital image based on a difference between the first exposure level and the second exposure level.

17. The system of claim 16, wherein the processor is configured for determining the second exposure level by at least determining an exposure level at which a threshold percentage of pixels of the digital image have a luminance value below a threshold luminance value.

18. The system of claim 16, wherein the processor is configured for determining the first exposure level by at least determining an exposure level based also at least on a histogram of the image.

19. The system of claim 16, wherein the processor is configured for adding the non-linear gain by at least adding a first gain to a first portion of the pixels and a second gain to a second portion of the pixels.

20. The system of claim 19, wherein the first portion of the pixels comprises a portion of pixels below a threshold luminance value.

21. The system of claim 19, wherein the first gain comprises a gain such that adding the first gain results in a second luminance level of each of the pixels of the first portion based on the first exposure level.

22. The system of claim 19, wherein the second gain comprises a gain such that adding the second gain results in a maximum luminance level based on the first exposure level.

23. The system of claim 16, wherein the processor is configured for adding the non-linear gain by at least adding a first gain to a first portion of the pixels and no gain to a second portion of the pixels.

24. The system of claim 16, wherein the processor is configured for adding the non-linear gain by at least adjusting a gamma correction factor.

25. The system of claim 16, wherein the processor is configured for adding the non-linear gain by at least adjusting a dynamic range compression factor.

26. The system of claim 16, wherein the first and second exposure levels are determined concurrently based on a first and second subset of the pixels, respectively.

27. The system of claim 16, wherein the threshold exposure level is determined for each color channel separately.

28. The system of claim 27, wherein the second exposure level is determined based on the lowest of the threshold exposure levels of each color channel.

29. The system of claim 27, wherein the second exposure level is determined based on a weighted average of the threshold exposure levels of each color channel.

30. The system of claim 16, wherein the second exposure level is determined based on:
comparing a difference between the first exposure and the second exposure level to a predetermined maximum difference; and
based on the comparison, setting the second exposure level to a level based on the first exposure level and the predetermined maximum difference.
